(19) United States
(12) Patent Application Publication
(10) Pub. No.: US 2022/0251899 A1
(43) Pub. Date: Aug. 11, 2022

(54) BICONICAL VARIABLE FORCE TRANSMISSION SELF-BALANCING LIFTING CURTAIN

(71) Applicant: Haisheng XU, GUANGDONG (CN)

(72) Inventor: Haisheng XU, GUANGDONG (CN)

(21) Appl. No.: 17/544,905

(22) Filed: Dec. 7, 2021

(30) Foreign Application Priority Data
Feb. 8, 2021 (CN) 202110171793.3

(51) Int. Cl. E06B 9/322; E06B 9/303

(52) U.S. Cl. CPC E06B 9/322; E06B 9/303

(57) ABSTRACT

The present invention relates to a biconical variable force transmission self-balancing lifting curtain, including a plurality of curtain sheets, a bottom rail, a traction rope, a lifting control piece and a variable force output structure, wherein the variable force output structure includes a first pull rope, a second pull rope, a variable force spring, a first conical reel and a second conical reel. Through the variable force spring in the variable force output structure, in the ascending process of the lifting curtain, a gradually-increased elastic force is provided; and further, two biconical reels are utilized, whereby the relationship of force arms at two ends is changed, and the elastic force of the variable force spring is amplified enough to balance the gradually-increased tensile force of the traction rope on the lifting control piece.

### BACKGROUND OF THE INVENTION

The present invention relates to the field of a lifting curtain, and in particular, to a biconical variable force transmission self-balancing lifting curtain.

In a lifting curtain, a curtain main body for sunshading includes a plurality of curtain sheets and a bottom rail at the bottom end, and a traction rope passes through a plurality of curtain sheets and is connected to the bottom rail. In the process of reeling the lifting curtain, the bottom rail ascends from the lowest point to the highest point, the plurality of curtain sheets are stacked on the bottom rail sequentially from bottom to top, and the tensile force of the bottom rail on the traction rope is larger and larger, so that it is more and more difficult to ascend the lifting curtain.

To solve the above problem, it is necessary to configure a counterweight or other structures capable of providing a tensile force at the other end of the control piece so as to balance the gradually increased weight in the ascending process of the curtain main body. With the urbanization construction, the scale of the building is getting larger and larger, and the size of the window is getting larger and larger, so the size of the required lifting curtain increases accordingly. It can be seen that in addition to the increased weight of the curtain main body caused by the ascending of the lifting curtain, the increasing size of the lifting curtain is even more troublesome for the industry. If the existing counterweight balancing method is adopted, it is necessary to provide a very large counterweight or an output structure with high power, resulting high manufacturing cost and a certain potential safety hazard.

The above problems are worth solving.

### BRIEF SUMMARY OF THE INVENTION

To overcome the shortcomings of the prior art, the present invention provides a biconical variable force transmission self-balancing lifting curtain.

The technical solution of the present invention is as follows:

a biconical variable force transmission self-balancing lifting curtain includes a plurality of curtain sheets, a bottom rail, a traction rope and a lifting control piece, wherein one end of the traction rope passes through the plurality of curtain sheets and is connected to the bottom rail, and the other end of the traction rope is connected to the lifting control piece. The biconical variable force transmission self-balancing lifting curtain further includes a variable force output structure, wherein the variable force output structure includes a first pull rope, a second pull rope, a variable force spring, and a first conical reel and a second conical reel which rotate synchronously; one end of the first pull rope is connected to the lifting control piece and the other end of the first pull rope is wound on the first conical reel, and a winding starting point is located at one end of the first conical reel with a larger radius; one end of the second pull rope is connected to the variable force spring and the other end of the second pull rope is wound on the second conical reel, and a winding starting point is located at one end of the second conical reel with a larger radius; and a winding direction of the first pull rope on the first conical reel is opposite to that of the second pull rope on the second conical reel.

The present invention according to the above solution is characterized in that the first conical reel and the second conical reel are connected through one central rotating shaft.

Further, a rotating shaft bracket is arranged between the first conical reel and the second conical reel, and the central rotating shaft passes through the rotating shaft bracket and slides in the rotating shaft bracket.

The present invention according to the above solution is characterized in that the first conical reel and the second conical reel are both provided with sliding areas, the bottom of the sliding area of the first conical reel is provided with a first supporting frame and slides on the first supporting frame, and the bottom of the sliding area of the second conical reel is provided with a second supporting frame and slides on the second supporting frame.

The present invention according to the above solution is characterized in that one end of the first conical reel with a larger radius and one end of the second conical reel with a larger radius are both provided with winding areas for winding pull ropes.

Further, a first steering fixed pulley is arranged at the bottom of the winding area of the first conical reel, and the first pull rope is wound on the winding area of the first conical reel through the first steering fixed pulley; and a second steering fixed pulley is arranged at the bottom of the winding area of the second conical reel, and the second pull rope is wound on the winding area of the second conical reel through the second steering fixed pulley.

Further, the two winding areas are both provided with wiring troughs for winding.

The present invention according to the above solution is characterized in that the first conical reel and the second conical reel are equal in size, and the first conical reel and the second conical reel are arranged symmetrically.

Preferably, one end of the first conical reel with a larger radius and one end of the second conical reel with a larger radius are located on inner sides.

Preferably, one end of the first conical reel with a larger radius and one end of the second conical reel with a larger radius are located on outer sides.

The present invention according to the above solution has the following beneficial effects:

through the variable force spring in the variable force output structure, in the ascending process of the lifting curtain, a gradually-increased elastic force is provided; and further, two biconical reels are utilized, the relationship of force arms at two ends is changed, and the elastic force of the variable force spring is amplified enough to balance the gradually-increased tensile force of the traction rope on the lifting control piece, thereby achieving the self-balancing effect.

On the other hand, the biconical variable force transmission self-balancing lifting curtain according to the present invention has the effect of amplifying the force, so it is only necessary to configure a small force to realize force balance, thereby greatly reducing the size and the cost of the lifting curtain.

### BRIEF DESCRIPTION OF THE DRAWINGS

FIG. 1 is a schematic structural diagram of an unreeled state of a lifting curtain according an embodiment I of the present invention;

FIG. 2 is an enlarged view of a variable force output structure in FIG. 1;

FIG. 3 is a schematic structural diagram of a reeled state of a lifting curtain according to an embodiment I of the present invention;

FIG. 4 is an enlarged view of a variable force output structure in FIG. 3; and

FIG. 5 is a schematic diagram of a variable force output structure according to an embodiment II of the present invention.

In the drawings, 1. Lifting curtain; 11. curtain sheet; 12. Bottom rail; 13. Traction rope; 14. Lifting control piece;

2. Variable force output structure; 21. First pull rope; 22. Second pull rope; 23. First conical reel; 24. Second conical reel; 25. First steering fixed pulley; 26. Second steering fixed pulley; 27. Central rotating shaft; 271. Rotating shaft bracket; 28. Variable force spring; 201. Winding area; 202. Sliding area; 2021. First supporting frame; 2022. Second supporting frame.

### DETAILED DESCRIPTION OF THE INVENTION

In order to better understand the objectives, technical solutions and technical effects of the present invention, the present invention will be further described below with reference to the accompanying drawings and embodiments. Meanwhile, it is stated that the embodiments described below are merely used to explain the present invention and are not used to limit the present invention.

It should be noted that when an component is referred to as being “fixed” or “arranged” on another component, the component may be directly arranged on another component or a central component may be present. When one component is considered as being “connected” to another component, the component may be directly connected to another component or a central component may be present at the same time.

Orientations or positions indicated by terms “upper”, “lower”, “left”, “right”, “front”, “back”, “vertical”, “horizontal”, “top”, “bottom”, “inner” and “outer” are orientations or positions as shown in the drawings, and these terms are only intended to facilitate description and shall not be understood as a limitation to the technical solution.

The terms “first” and “second” are used only for facilitating description and shall not be interpreted as an indication or implication of relative importance or an implicit indication of the number of technical features.

“A plurality of” means two or more, unless otherwise specifically defined.

### Embodiment I

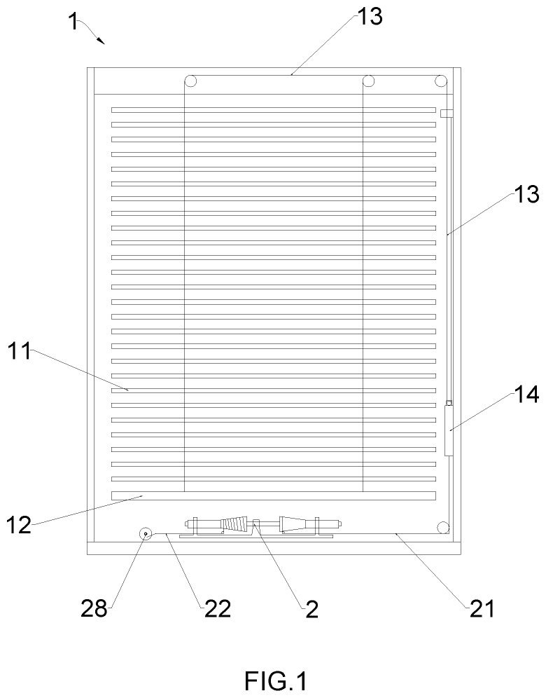

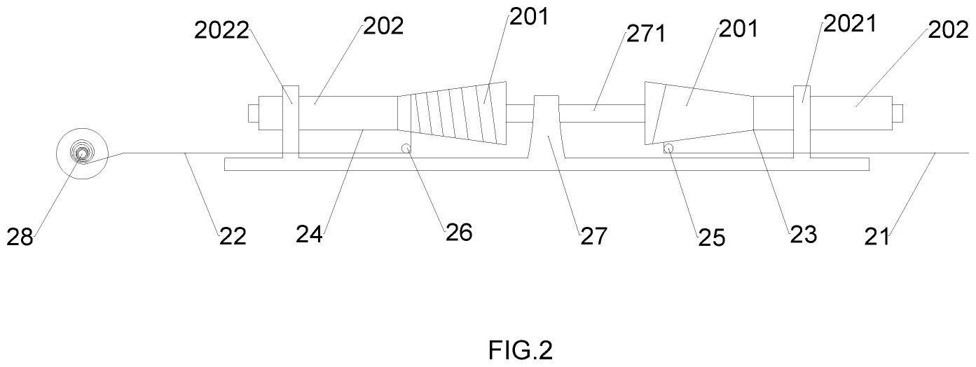

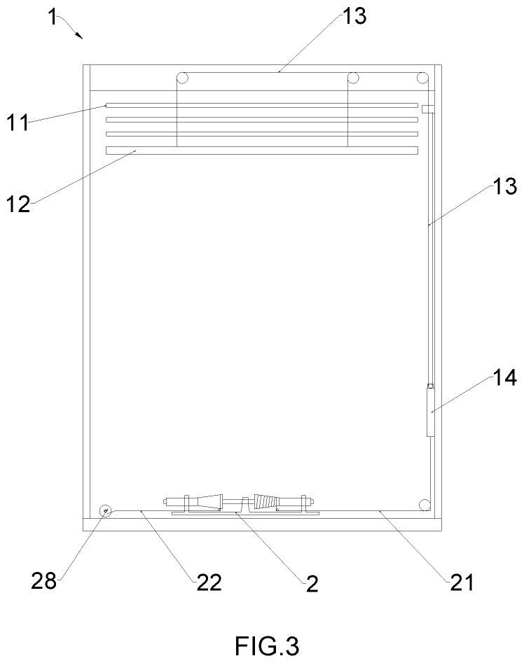

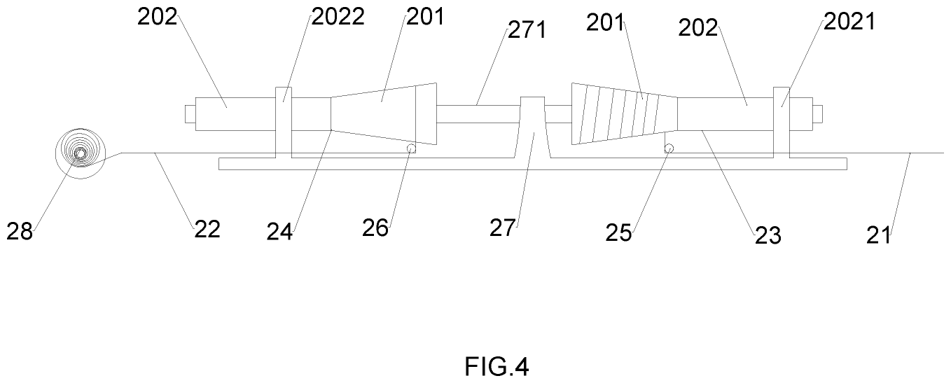

As shown in FIG. 1 to FIG. 4, a biconical variable force transmission self-balancing lifting curtain includes a plurality of curtain sheets 11, a bottom rail 12, a traction rope 13 and a lifting control piece 14, wherein one end of the traction rope 13 passes through the plurality of curtain sheets 11 and is connected to the bottom rail 12, and the other end of the traction rope 13 is connected to the lifting control piece 14; the other end of the lifting control piece 14 is connected to a variable force output structure 2; and the variable force output structure 2 is provided with a variable force spring 28 for providing a variable force for the lifting control piece 14.

The curtain sheets 11 of the lifting curtain 1 are connected to a top frame of the lifting curtain 1 in series through a connecting line (not shown in the figure, the same below); the curtain sheets 11 are suspended above the bottom rail 12; and one end of the traction rope 13 passes through the curtain sheets 11 and is fixed on the bottom rail 12, and the other end of the traction rope 13 is connected to the lifting control piece 14. When the lifting control piece 14 is operated to ascend the bottom rail 12 from the lowest point to the highest point (that is, the curtain ascending process), the plurality of curtain sheets 11 are stacked on the bottom rail 12 sequentially from bottom to top, the gravity of the curtain sheets applies pressure to the bottom rail 12, and the pressure increases as the number of the stacked curtains increases, so the tensile force of the traction rope 13 on the lifting control piece 14 increases gradually; and when the lifting control piece 14 is operated to descend the bottom rail 12 from the highest point to the lowest point (that is, the curtain descending process), the plurality of curtain sheets 11 are separated from the bottom rail 12 sequentially from top to bottom, and the pressure applied to the bottom rail 12 decreases as the number of the stacked curtain sheets decreases, so the tensile force of the traction rope 13 on the lifting control piece 14 decreases gradually.

According to the present invention, the variable force spring 28 of the variable force output structure 2 outputs a variable force to balance the variable tensile force of the traction rope 13 on the lifting control piece 14 in the lifting process of the lifting curtain.

In the present invention, the variable force output structure 2 includes a first pull rope 21, a second pull rope 22, a variable force spring 28, and a first conical reel 23 and a second conical reel 24 which rotate synchronously, wherein one end of the first pull rope 21 is connected to the lifting control piece 14 and the other end of the first pull rope 21 is wound on the first conical reel 23, and a winding starting point is located at one end of the first conical reel 23 with a larger radius; and one end of the second pull rope 22 is connected to the variable force spring 28 and the other end of the second pull rope 22 is wound on the second conical reel 24, and a winding starting point is located at one end of the second conical reel 24 with a larger radius.

A winding direction of the first pull rope 21 on the first conical reel 23 is opposite to that of the second pull rope 22 on the second conical reel 24. Since the first conical reel 23 and the second conical reel 24 rotate in the same direction, if the first conical reel 23 reels the wire during rotation, the second conical reel 24 unreels the wire, that is, the first pull rope 21 is gradually wound on the first conical reel 23. Since a winding starting point is located at one end with a larger radius, the winding starts from one end with the larger radius, the second pull rope 22 is gradually released from the second conical reel 24 and from one end with a smaller radius.

In summary, the specific working process and principle of the present invention are:

the lifting control piece 14 is operated to ascend the lifting curtain, the first pull rope 21 is gradually wound on the first conical reel 23 from one end of the first conical reel 23 with a larger radius to one end with a smaller radius, so the arm of force (L1) of the first pull rope 21 on the first conical reel 23 gradually decreases; and the second pull rope 22 is gradually released from the second conical reel 24 and the wire is unreeled from one end of the second conical reel 24 with a smaller radius to one end with a larger radius, so the arm of force (L2) of the second pull rope 22 on the second conical reel 24 gradually increases. At this time, the variable force spring 28 rewinds and the elastic force is larger and larger, so that the force of the second pull rope 22 acting on the second conical reel 24 is increased.

Assuming that the action force of the first pull rope on the first conical reel is F1 and the arm of force is L1, and the action force of the second pull rope on the second conical reel is F2 and the arm of force is L2, according to a moment formula, that is, the moment is equal to the product of the force and the arm of force, M1=F1×L1 and M2=F2×L2 can be obtained. To keep the forces at two ends of the lifting control piece balanced, M1=M2, that is, F1×L1=F2×L2. It can be seen from the above that F1 increases with the ascending of the lifting curtain. In order to balance F1, the effect of amplifying the elastic force of the variable force spring is achieved by reducing the arm of force L1 and increasing the arm of force L2, so that a force sufficient to balance F1 can be obtained, thereby balancing the forces at the two ends of the lifting control piece 14 and solving the problem of difficulty when the lifting curtain ascends.

Through the variable force spring in the variable force output structure, in the ascending process of the lifting curtain, a gradually-increased elastic force is provided; and further, two biconical reels are utilized, the relationship of force arms at two ends is changed, and the elastic force of the variable force spring is amplified enough to balance the gradually-increased tensile force of the traction rope on the lifting control piece. On the other hand, the biconical reel structure according to the present invention has the effect of amplifying the force, so it is only necessary to provide a smaller force to realize force balance, thereby greatly reducing the size and cost of the lifting curtain.

In this embodiment, the first conical reel 23 and the second conical reel 24 are connected through one central rotating shaft 27. Further, a rotating shaft bracket 271 is arranged between the first conical reel 23 and the second conical reel 24, and the central rotating shaft 27 passes through the rotating shaft bracket 271 and slides in the rotating shaft bracket 271. When the lifting curtain ascends, within the reeling of the first conical reel 23 and the unreeling of the second conical reel 24, the two conical reels move jointly towards the second conical reel 24 through the central rotating shaft 27; and when the lifting curtain descends, with the unreeling of the first conical reel 23 and the reeling of the second conical reel 24, the two conical reels move jointly towards the first conical reel 23 through the central rotating shaft 27.

In this embodiment, the first conical reel 23 and the second conical reel 24 are both provided with sliding areas 202, the bottom of the sliding area 202 of the first conical reel 23 is provided with a first supporting frame 2021 and slides on the first supporting frame 2021, and the bottom of the sliding area 202 of the second conical reel 24 is provided with a second supporting frame 2022 and slides on the second supporting frame 2022. The design has the effect of stabilizing the conical reels so as to prevent displacement of the two conical reels in the process of sliding back and forth and avoid the influence on the reeling and unreeling of the pull ropes on the conical reels, thereby avoiding the influence on the transmission of the input force (that is, the action force of the variable force spring).

In this embodiment, one end of the first conical reel 23 with a larger radius and one end of the second conical reel 24 with a larger radius are both provided with winding areas 201 for winding the pull ropes. Further, a first steering fixed pulley 25 is arranged at the bottom of the winding area 201 of the first conical reel 23, the first pull rope 21 is wound on the winding area 201 of the first conical reel 23 through the first steering fixed pulley 25, a second steering fixed pulley 26 is arranged at the bottom of the winding area 201 of the second conical reel 24, and the second pull rope 22 is wound on the winding area 201 of the second conical reel 24 through the second steering fixed pulley 26. The steering fixed pulley is designed to change the direction of the force of the pull rope, so that the force of the pull rope is still perpendicular to the axis of the conical reel, component forces in other directions are avoided, the action forces at two ends act on the conical reel maximally, and the transfer efficiency of the force is improved.

In this embodiment, the two winding areas 201 are both provided with wiring troughs for winding. The wiring trough is used to enhance the firmness of the pull rope wound on the conical reel and improve the stability of the biconical variable force transmission structure.

In this embodiment, the first conical reel 23 and the second conical reel 24 are equal in size, and the first conical reel 23 and the second conical reel 24 are arranged symmetrically. Preferably, one end of the first conical reel 23 with a larger radius and one end of the second conical reel 24 with a larger radius are located on inner sides, that is, the ends of the two conical reels with larger radius are opposite to each other and close to the rotating shaft bracket 271, and the ends of the two conical reels with smaller radius are located on two sides.

### Embodiment II

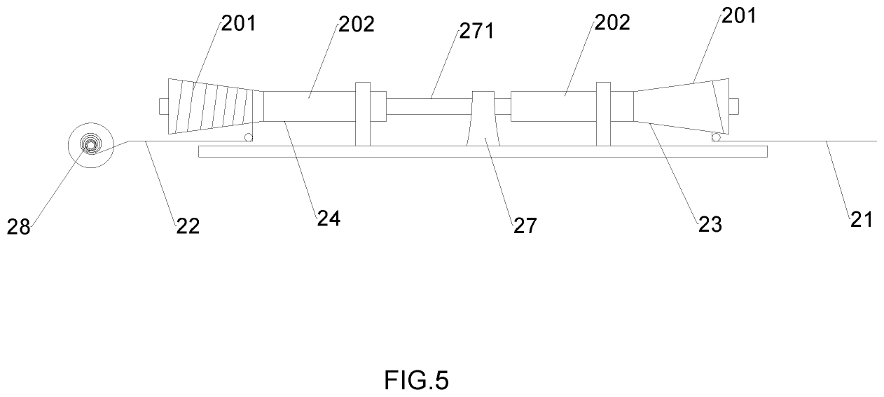

as shown in FIG. 5, this embodiment provides a biconical variable force transmission self-balancing lifting curtain. The structure is as same as that in the embodiment I, and the difference is that: one end of the first conical reel 23 with a larger radius and one end of the second conical reel 24 with a larger radius are located on outer sides, that is, the ends of the two conical reels with smaller radius are opposite to each other and close to the rotating shaft bracket 271, and the ends of the two conical reels with larger radius are located on two sides.

Although the variable force output structure in this embodiment is different from that in the embodiment I, this embodiment also has the effects of reducing the arm of force of the tensile force on one side of the lifting curtain and increasing the arm of force of the tensile force on one side of the variable force spring so as to amplify the output force (that is, the elastic force) by utilizing the arm of force relationship between two sides of the biconical reel structure.

The technical features of the foregoing embodiments can be arbitrarily combined. To simplify the descriptions, all possible combinations of the technical features in the above embodiments have not been described. However, as long as there is no contradiction in the combinations of these technical features, the combinations should be considered as the scope described in this specification.

The foregoing embodiments only express several implementations of the present invention Descriptions of the foregoing implementations are relatively specific and detailed, but cannot be understood as limiting the scope of the patent for the present invention. It should be noted that, for those of ordinary skill in the art, without departing from the concept of the present invention, modifications and improvements can be further made, and all belong to the protection scope of the present invention. Therefore, the protection scope of the patent for the present invention shall be subject to the appended claims.

What is claimed is:

1. A biconical variable force transmission self-balancing lifting curtain, comprising a plurality of curtain sheets, a bottom rail, a traction rope and a lifting control piece, and further comprising a variable force output structure, wherein one end of the traction rope passes through the plurality of curtain sheets and are connected to the bottom rail, and the other end of the traction rope is connected to the lifting control piece; the variable force output structure comprises a first pull rope, a second pull rope, a variable force spring, and a first conical reel and a second conical reel which rotate synchronously;
one end of the first pull rope is connected to the lifting control piece and the other end of the first pull rope is wound on the first conical reel, and a winding starting point is located at one end of the first conical reel with a larger radius;
one end of the second pull rope is connected to the variable force spring and the other end of the second pull rope is wound on the second conical reel, and a winding starting point is located at one end of the second conical reel with a larger radius; and
a winding direction of the first pull rope on the first conical reel is opposite to that of the second pull rope on the second conical reel.

2. The biconical variable force transmission self-balancing lifting curtain according to claim 1, wherein the first conical reel and the second conical reel are connected through one central rotating shaft.

3. The biconical variable force transmission self-balancing lifting curtain according to claim 2, wherein a rotating shaft bracket is arranged between the first conical reel and the second conical reel, and the central rotating shaft passes through the rotating shaft bracket and slides in the rotating shaft bracket.

4. The biconical variable force transmission self-balancing lifting curtain according to claim 1, wherein the first conical reel and the second conical reel are both provided with sliding areas, the bottom of the sliding area of the first conical reel is provided with a first supporting frame and slides on the first supporting frame, and the bottom of the sliding area of the second conical reel is provided with a second supporting frame and slides on the second supporting frame.

5. The biconical variable force transmission self-balancing lifting curtain according to claim 1, wherein one end of the first conical reel with a larger radius and one end of the second conical reel with a larger radius are both provided with winding areas for winding pull ropes.

6. The biconical variable force transmission self-balancing lifting curtain according to claim 5, wherein a first steering fixed pulley is arranged at the bottom of the winding area of the first conical reel, and the first pull rope is wound on the winding area of the first conical reel through the first steering fixed pulley; and
a second steering fixed pulley is arranged at the bottom of the winding area of the second conical reel, and the second pull rope is wound on the winding area of the second conical reel through the second steering fixed pulley.

7. The biconical variable force transmission self-balancing lifting curtain according to claim 5, wherein the two winding areas are provided with wiring troughs for winding.

8. The biconical variable force transmission self-balancing lifting curtain according to claim 1, wherein the first conical reel and the second conical reel are equal in size, and the first conical reel and the second conical reel are arranged symmetrically.

9. The biconical variable force transmission self-balancing lifting curtain according to claim 8, wherein one end of the first conical reel with a larger radius and one end of the second conical reel with a larger radius are located on inner sides.

10. The biconical variable force transmission self-balancing lifting curtain according to claim 8, wherein one end of the first conical reel with a larger radius and one end of the second conical reel with a larger radius are located on outer sides.
